(19) United States
(12) Patent Application Publication
(10) Pub. No.: US 2009/0076854 A1
(43) Pub. Date: Mar. 19, 2009

(54) METHODS AND SYSTEMS FOR SAVING ON HEALTHCARE COSTS

(75) Inventor: Bruce C. Bigsby, Roswell, GA (US)

Correspondence Address: NORA M. TOCUPS, P.O BOX 698, 140 PINECREST AVE, DECATUR, GA, 30030, US

(73) Assignee: GLOBALCARE, INC., Alpharetta, GA (US)

(21) Appl. No.: 12/211,041

(22) Filed: Sep. 15, 2008

Related U.S. Application Data
(60) Provisional application No. 60/972,223, filed on Sep. 13, 2007.

(51) Int. Cl. G06Q 50/00

(52) U.S. Cl. 705/3; 705/2

(57) ABSTRACT

A payer may save on healthcare costs and a service provider may receive information about payment according to the inventions. Data about service providers eligible to provide services to patients at in-network rates may be made available. A user seeking a service may select a service provider from the data made available. From the network(s) in which the selected service provider participates, a matching network may be chosen. If the selected service provider participates in more than one network, access and/or savings data for each network may be used to determine the match. Other factors may determine the match. Information relating to the user and matched network is provided to the selected service provider, who or which charges in-network rates for service to the user. The payer may be charged a portion of its savings for their accomplishment.

### CROSS-REFERENCE TO RELATED APPLICATION

The present application claims priority to and benefit of the prior filed co-pending and commonly owned provisional application, filed in the United States Patent and Trademark Office on Sep. 13, 2007, assigned Ser. No. 60/972,223 entitled Methods and Systems for Saving on Healthcare Costs, and incorporated herein by reference.

### FIELD OF THE INVENTIONS

The invention relates to methods and systems for i) obtaining the best or close as possible to the best available pricing for healthcare services and ii) providing the provider of the healthcare services with service information regarding how the medical bill will be priced and paid. Particularly, the inventions relate to methods and systems for striving to obtain the most advantageous discount available with respect to the cost of healthcare services and to substantially satisfy the provider's need to understand how the medical bill will be priced and paid.

### BACKGROUND

Claim: A medical bill or invoice for service or services rendered.

Payer: An entity that accepts claims, applies healthcare benefits to the claims, and pays the provider according to the applicable healthcare benefit plans. Typically, a payer is an insurance carrier, health maintenance organization, third party payer, or the like.

Plan sponsor: An entity that has the fiduciary responsibility for the healthcare benefits applied to claims. Typically, a plan sponsor is an insurance carrier, health maintenance organization, self-funded employer, Taft-Hartley Trust, or the like. A plan sponsor may also be a payer.

Preferred Provider Organization (PPO): An entity that obtains and secures contracts with providers to pay for medical services at a discounted amount off of standard charges in return for assurance of timely payment for qualifying medical services and overt steerage of potential patients or users to the participating providers.

Provider: A doctor, a medical care giver, hospital, medical care facility, licensed medical professional, service provider or the like.

Third Party Administrator (TPA): An entity that may design and administer the healthcare benefits plan on behalf of another entity such as an employer.

User: A person who may be accorded health care benefits according to a health care plan from a payer or plan sponsor, who may seek medical care from a provider, and who may also be referred to as a “patient”. In some cases, the “user” may be the person to whom the healthcare benefits are accorded, but the patient may be somebody other than the user. The terms “user” and “patient” are used interchangeably herein unless specifically noted otherwise.

Many employers in the United States offer some type of healthcare benefits to their employees. Either the employer self-insures for the claims incurred (and is therefore a plan sponsor) or the employer offers an insured product made available through a healthcare insurance company (which then is the plan sponsor).

If the employer chooses to self-insure, the employer typically outsources the business of designing and administering the healthcare benefits plan to a third party, aptly referred to as a third party administrator (“TPA”—a payer). Alternatively, the employer may choose to have a healthcare insurance company provide the healthcare benefits. Such entities (“Health plans”, “HMOs” as payers) typically design, underwrite, and administer healthcare benefit plans in-house.

One of the fundamental mechanisms available to reduce medical costs is a system of contractually negotiated discounted rates with doctors and hospitals (providers). A contracting entity may approach a provider with the promise of an increase in business and timely payment for services from a reliable payer. In return, the provider may agree to discount its services. These provider contracts are grouped into “provider networks” or “preferred provider organization (PPO) networks”.

The provider commits to the discount and in return obtains contractual stipulations to ensure the provider receives the promised increase in volume and timely payment. These contractual stipulations usually also include the following:
i) a patient to be accorded the discount must present a healthcare benefits identification card that on its face identifies the name and carries the logo for the PPO network;
ii) a financial differential wherein a consequence of the patient's benefit plan is a 10% to 20% lower cost to the patient for “in-network” medical services versus “out-of-network” medical services;
iii) an obligation to pay a “clean claim” within thirty (30) days;
iv) an obligation to declare the PPO network that was accessed to take the discount on the Explanation of Payment sent to the provider; and
v) a commitment to a single preferred network in a specified geographic area.
   It is not uncommon for a provider to have contracts with 10 to 20 different PPO networks.

Healthcare benefit plans may encourage a patient to go to a doctor who is “on the list” of contracted providers (or in-network) such as by delivering lower costs to the patient for services rendered by a participating provider (e.g. 90% of the cost of care paid by the benefits plan for in-network provider versus 70% of the cost of the care paid by the benefits plan for an out-of-network provider). The savings to the plan sponsor and payer by encouraging patients to go in-network may be significant.

Even so, patients may go to providers that are not participating providers with the applicable PPO and the patients may obtain services (emergency care, a doctor the patient has used for years, etc.) from these non-participating providers. Payers then receive claims from these providers with whom the payer does not have a contracted discount. The payer is obligated to pay for the full amount of the bill as submitted. Typically, the full amount of a bill for medical services is much higher than the negotiated rates in a PPO network.

A goal of payers and plan sponsors is for patients to always or nearly always go in-network. Historically, this has been substantially achieved by enrolling all of the employees and qualifying dependents of a healthcare benefits plan in a specified geography with a specific PPO network. The payer distributes healthcare benefits identification cards with the specified PPO logo and name on the front of the cards. Such a card is to be presented by a patient at the time of service. Payers may provide a listing of the participating providers to the employees and dependents that have been enrolled with a specific PPO network. Payers also may allow patients to search for participating providers by accessing a telephone-based customer service center, through a Web-based internet query, and/or otherwise.

On the other side of this market equation, a provider may establish many different financial deals with many different PPOs. Each such contract typically differs in structure, discount level and PPO responsibilities. As a result, a provider may find it difficult and administratively complex to determine the amount the provider is due from a PPO for services rendered to a patient rendered and the amount the provider is due from the patient as a co-pay and/or otherwise.

### SUMMARY

Generally stated, the methods and systems of the invention strive to obtain the best or close to the best available pricing for healthcare services, and to deliver a service notification to the provider that may answers questions such as: “how is the claim to be priced?” and “what is the patient's liability?” Particularly, the methods and systems strive to obtain the best available pricing by striving to obtain the most advantageous discount available with respect to the cost of healthcare services. The inventions are described herein as including specific actions and having specific elements and features, but should not be limited to the particular examples given. In some embodiments, the order of the actions or elements may vary from those described herein. One or more of the inventions may be used in other circumstances and/or with other actions, elements or features.

Still generally stated, the methods and systems of the invention generally “clothe” a patient who seeks care from a provider without regard to whether the provider is inside or outside the patient's primary or local network so that in each instance, the patient appears to be, and actually may be, a member of a network in which the provider participates. Thus, the price of the service obtained by the patient is not the “full cost” as would be charged an out-of-network patient, but rather, typically a discounted price as would be charged a member of the provider's network.

The advantages are numerous. Some of the advantages to the patient include lower healthcare costs such as lower deductibles, and also significant service and support in finding healthcare providers. Some of the advantages to healthcare providers include the steerage of additional patients to their services and prompt and complete payment of the reduced fees. Some of the advantages to payers are the savings in payments made to healthcare providers, and the increase in marketability of their services based on the savings in healthcare costs that may be passed on to the patients as well as other advantages. Another benefit to healthcare providers is the substantial satisfaction of the need to understand how the medical bill will be priced and paid; which in turn improves the ability to collect the actual patient liability for medical care at the time of service.

The inventions may be implemented in various ways. A first embodiment of the inventions may be characterized as a method for a payer to save on healthcare costs with respect to a user seeking healthcare service, and for a service provider to be informed about payment for the healthcare service. In this embodiment, data about eligible healthcare service providers may be made available. A request may be received for an eligible healthcare service provider to provide healthcare service to a user. The service provider may be out-of-network.

A matched preferred provider organization (PPO) network for the eligible healthcare service provider is determined from among the one or more PPO networks in which the healthcare service provider may participate. If the healthcare service provider participates in more than one PPO network, the matched PPO network may be determined in a number of different ways. For example, access data for each of the PPO networks may be determined. The PPO networks may be ranked based on the access data determination. The top ranked PPO network may be selected as the matched PPO network. As an alternative, the access data for each of the PPO networks may be normalized, and the PPO networks may be ranked based on the normalized access data.

Another way to determine a matched PPO network is on the basis of savings data. Such data may be determined for each of the PPO networks in which the healthcare service provider participates. The PPO networks may be ranked based on their respective savings data. The top ranked PPO network may be selected as the matched PPO network. An additional possibility is that each of the determined savings data may be normalized, and the PPO networks may be ranked based on their respective normalized savings data.

Yet another way to determine a matched PPO network is to carry out both the access data and savings data determinations (normalized or not) with respect to each of the PPO networks in which the healthcare service provider participates. The top-ranked network after the combination determination may be selected as the matched PPO network.

A feature of the exemplary method is that prior to selection of the top ranked PPO network as the matched PPO network, the ranking of the PPO networks may be changed based on one or more factors such as factors other than the access data or savings data determinations. The matched PPO network may be selected from the changed ranking of the PPO networks.

Once the matched PPO network is determined (and/or at other time(s)), the exemplary method may verify the participation of the healthcare service provider in the matched PPO network.

The exemplary method may provide the healthcare service provider with information at least relating to the user and the matched PPO network. The information may cause the healthcare service provider to charge for the healthcare service provided to the user as the healthcare service provider charges an in-network user of the matched PPO network. The user also may be provided with the information at least relating to the user and the matched PPO network.

By the exemplary method, the payer may save on healthcare costs because the user is charged for the healthcare service as an in-network user of the matched PPO network. If an entity or business other than the payer carries out the exemplary embodiment, the payer may be billed for such services by such business or entity. The payer may be billed at least a portion of what the payer saves on the healthcare costs. Further or in the alternative, payment may be requested of the payer at least for providing the healthcare service provider with the information relating to the user and the matched PPO network. In some cases, the matched PPO network may be paid for its participation such as its participation by the reference to the matched PPO network made in the information provided to the healthcare service provider. Also by this embodiment, the healthcare service provider may be informed about the payment for the healthcare service at least by reference to the provided information relating at least to the user and the matched PPO network.

Another exemplary embodiment of the inventions may be characterized as a method to obtain a favorable rate for a patient for medical care from a medical care giver, who may be out-of-network. Per this exemplary method, an inquiry about medical care may be received. The inquiry may be made for service to a patient in a region which is inside and/or outside a region covered by the patient's network. Data may be made available about one or more medical care givers eligible to provide the medical care at a favorable rate. In response to receiving identification of a medical care giver selected from the available data, the selected medical care giver may be instructed or caused to charge the favorable rate for the medical care. Causing the selected medical care giver to charge the favorable rate may be accomplished by providing the selected medical care giver with a care notice at least identifying the patient as associated with a network in which the selected medical care giver participates.

The exemplary method may carry out the identification of a patient as associated with a network in a number of ways. For example, a determination may be made of the one or more networks in which the selected medical care giver participates. One of the determined networks may be selected for associating with the patient in the care notice.

If the party responsible for the medical care costs of the patient is not the business or entity that obtains the favorable rate for the medical care provided to the patient by the selected medical care giver, then the responsible party such as a payer or plan sponsor may be charged for such actions.

Yet another exemplary embodiment of the inventions may be characterized as a method of providing healthcare payment information to a healthcare provider with the information relating to a patient receiving healthcare service from the healthcare provider at an in-network rate. This exemplary method may provide the healthcare provider with a service notification. The service notification may identify the patient and a network in which the healthcare provider participates and with which the patient is associated. The service notification also may include a co-pay to be paid by the patient for the healthcare service provided by the healthcare provider. The identification in the service notification of the network in which the healthcare provider participates and with which the patient is associated allows the healthcare provider to determine the rate for the healthcare service to be charged for the service to the patient.

Another exemplary embodiment of the inventions may be characterized as a method of providing healthcare payment information to a healthcare provider with the information relating to an in-network patient receiving healthcare service from the healthcare provider at an in-network rate. This exemplary method may provide the healthcare provider with a service notification. The service notification may identify the in-network patient and a network in which the healthcare provider participates and with which the in-network patient is associated. The service notification also may include a co-pay to be paid by the patient for the healthcare service provided by the healthcare provider. The identification in the service notification of the network in which the healthcare provider participates and with which the in-network patient is associated allows the healthcare provider to confirm the in-network rate for the healthcare service to be charged for the service to the in-network patient and to more accurately establish the patient's liability for fees at the time of service.

Further, another exemplary embodiment of the inventions may be characterized as a method of obtaining a rate for a service provided to a patient comparable to what a patient associated with a network is charged for the service. The patient may be an in-area or an out-of-area patient. By this exemplary method, networks covering an area may be identified. Data may be compiled on the service providers providing service in the area and associated with one or more of the identified networks. In response to a request from a patient for a referral to a service provider selected from the data, a matching network may be determined from the one or more identified networks with which the selected service provider is associated. The selected service provider may be instructed to charge a rate for a service to the patient comparable to a rate charged to other patients associated with the matching network and receiving the service.

Exemplary embodiments according to the inventions have been summarized above. Many more are possible; the inventions are not to be limited to these examples. Other features and advantages of the inventions may be more clearly understood and appreciated from a review of the following detailed description and by reference to the appended drawings and claims.

### BRIEF DESCRIPTION OF THE DRAWINGS

FIG. 1 includes graphic aids to understanding an exemplary embodiment of the inventions.

FIG. 2 is a flow diagram associated with an exemplary embodiment of the inventions.

FIG. 3 is a flow diagram associated with an exemplary embodiment of the inventions.

FIG. 4 is a flow diagram associated with an exemplary embodiment of the inventions.

### DETAILED DESCRIPTION

The inventions are described herein with reference to exemplary embodiments, alternative embodiments, and also with reference to the attached drawings. The inventions, however, can be embodied in many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

An exemplary embodiment of the inventions is described in connection with a healthcare environment. Assume a patient has medical insurance coverage through a PPO. The PPO assigns the patient a network of service providers. The network of service providers may be a “local network” in that the service providers may be located generally in the patient's local geographic area. The phrase “local network” may be used interchangeably herein with “in-network” or “in-area”, unless otherwise noted.

In some cases, the patient may seek medical care from services providers outside the local network (also referred to as “out-of network”, “out-of-area”, or “visited area”). Ordinarily, however, the result of seeking care outside the local network is that the patient (and/or in some cases his/her insurer) is charged higher fees (such as full cost) for such out-of-network services. In direct contrast, the exemplary embodiment may allow the patient to obtain services out-of-network, but at less than the ordinarily high fees for out-of-network service.

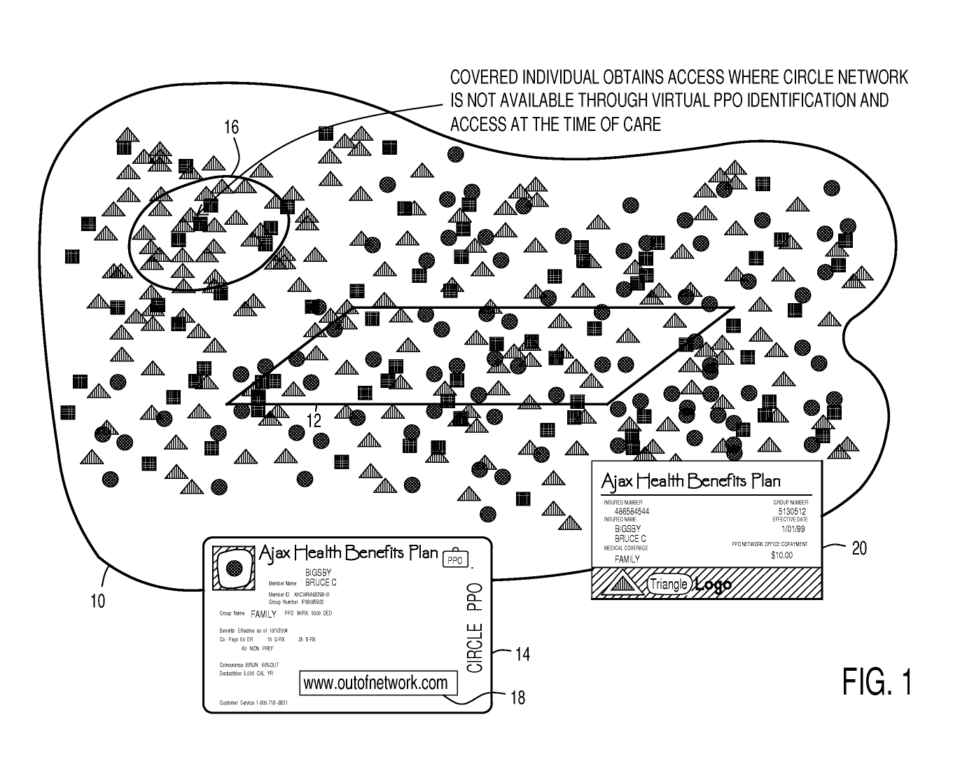

FIG. 1 includes graphic aids to understanding an exemplary embodiment of the inventions. FIG. 1 may aid in the reader's understanding of how an out-of-network patient may be treated as a local network patient according to an exemplary embodiment of the inventions. FIG. 1 includes a general geographic area 10 with circles, squares, and triangles distributed throughout. The circles, squares, and triangles represent locations of service providers (such as doctors, hospitals, etc.) and their respective PPO network affiliations. For this example, three different PPO networks operate within this general geographic area 10. A service provider may participate in one, two or all three of the PPO networks. A first PPO network is represented by a circle; a second network is represented by a square; and a third network is represented by a triangle.

Assume Ajax is an employer with employees living and/or employed within the area generally defined by the quadrilateral 12 (“Ajax area 12”) within the general area 10. The Ajax Health Benefits Plan offers medical insurance coverage through a PPO. The PPO has assigned employees of the Ajax Health Benefits Plan to the circle PPO network as the local network of service providers for Ajax employees.

Ajax employees are issued an insurance card. A card 14 of Ajax employee Bruce C. Bigsby is shown in FIG. 1 (“circle card 14”). The circle card 14 identifies Bruce C. Bigsby and also identifies the circle network as his local network. The circle network may be identified on a card in a number of ways, but typically, a PPO logo and name are used as identifiers as shown on the circle card 14. The PPO logo also may be referred to herein as the “PPO trademark”. To obtain medical services whose cost is covered as much as possible by his health insurance, Bruce may seek a service provider that participates in the circle network within the Ajax area 12. Bruce presents his circle card 14 at the time of service to demonstrate he is covered by health insurance through payer(s) that participate in the circle network.

Assume Bruce travels outside the Ajax area 12 to an area referred to herein as the “visited area 16”. Bruce experiences a medical problem while in the visited area 16 and must seek medical attention. Bruce finds, however, there are no service providers in the visited area 16 that participate in the circle network. But there are service providers in the visited area 16 that participate in the square network and/or the triangle network. Advantageously, Bruce's employer Ajax participates in a plan according to an exemplary embodiment of the inventions where Bruce may obtain medical services in the visited area 16 without incurring “out-of-network” charges and has appropriate access under these circumstances to the red triangle and yellow square network contracts.

To obtain service without incurring out-of-network charges, Bruce may access a web-site identified on his circle card 14 as “www.outofnetwork.com” 18. Bruce may use the website to select a healthcare provider in the visited area 16. Other embodiments of the inventions may allow Bruce to select a provider in ways other than accessing a website. In other words, information about eligible service providers available to users such as Bruce may be made available in a variety of ways. A website may provide information about eligible providers. A directory or other printed publication may provide data about eligible care givers. Such information and data about eligible care givers may be made available to users by their access through a toll-free telephone number.

After Bruce has selected a healthcare provider in the visited area 16, an appropriate PPO network for the selected provider may be identified. The identified PPO network may be referred to herein as a matching or matched network. In this example, the PPO network corresponding to the provider selected by Bruce is the triangle network.

To further facilitate Bruce's obtaining services from a selected provider in the visited area 16 at a local network rate, the exemplary embodiment may provide Bruce with documentation to present to the selected service provider. The document may be referred to as a “service notification”, “information”, “ticket”, “health ticket”, “healthcare card”, “healthcare document”, or a “care notice” herein. The document may be provided to Bruce in any appropriate manner. For example, the document may be electronically provided to Bruce. In that case, the document may be referred to as an “electronic healthcare card”.

The exemplary embodiment may provide Bruce with a new health insurance card configured to identify Bruce as an in-network patient and/or to identify Bruce as a member or otherwise associated with the triangle network. FIG. 1 illustrates an exemplary triangle card 20 that might be issued or made available to Bruce. When Bruce presents the triangle card 20 as his health insurance card, he is treated by the selected provider as a participant in the triangle network and not as an “outsider”.

So Bruce may obtain medical services in the visited area 16 without incurring out-of-network charges, the exemplary embodiment may provide a service notification to the out-of-network service provider. The service notification may inform the out-of-network service provider that the patient is to be treated as an in-network patient. In other words, the patient is to be treated as if he or she is a participant in one of the networks in which the service provider participates. In effect, the service notification makes the patient look like (and in fact, administratively and contractually may be set up to be) an “in-network” patient to the service provider located outside the patient's local network area. The service notification makes the patient look like (and administratively and contractually may be) an “in-network” patient by the service notification, which may display an identifier (name, logo) of a PPO organization in which the service provider participates. The service notification may further display benefit related patient liability information.

The exemplary embodiment may notify the payer(s) of Bruce's health insurance benefits of the facts relating to Bruce's visit to an out-of-network service provider. In this example, the payer is Ajax. The exemplary embodiment may provide Ajax with details relating to Bruce's visit to the out-of-network service provider. These details may include the name of the provider and the PPO network that was accessed as the appropriate PPO network.

As noted above, the exemplary embodiment may provide information on eligible service providers and appropriate PPO networks to beneficiaries of health insurance policies such as Bruce. The exemplary embodiment may provide such information or makes it available to service providers. Already noted above, the exemplary embodiment may provide a service provider with a service notification with respect to a pending visit from a patient who would otherwise be treated as out-of-network. Other resources and information may be made available to service providers by the exemplary embodiment. If a provider has questions or wants another copy of the appropriate documentation, the provider may access or contact the same web-site as noted above (www.outofnetwork.com), and/or another resource.

With respect to payment for the care provided to the patient, the service provider may submit a claim to according to the documentation provided by the exemplary embodiment and/or the patient. Based upon the information provided by the exemplary embodiment, the provider may clearly understand that the claim will be re-priced to a discounted amount. The provider also may know which PPO contract will be the basis for the discounted amount.

Alternatively or in addition, the service provider may submit the claim to a third-party (such as a third-party running an exemplary embodiment on behalf of one or more payers). The third-party may interact with the payer in any number of ways such as a way in which the result is the payer paying the discounted amount to the provider (either through the third-party, otherwise indirectly, or directly). In some cases, the individual may have to make a co-payment or other payment to the service provider. Per the exemplary embodiment, the payer may inform the covered individual of his or her liability to the provider based upon the discounted amount, the individual's benefit plan, and/or other factors. The matter may be closed by the covered individual paying off any obligation owing to the provider.

An exemplary embodiment of the inventions may include actions and elements that may be characterized as set up or organizational with respect to one or more of the actions in the embodiments discussed above. For example, a business or other entity may implement and carry out (in whole or in part) a program whose aim is to save a payer or plan sponsor money. The business may implement the program in exchange for payment such as a percentage of the savings to the payer as a result of the program. The business or other entity may be a person(s), partnership, corporation, etc. On behalf of a payer or plan sponsor, the business may implement an exemplary embodiment of the inventions such as a method of obtaining a comparable rate for a service provided to an out-of-area patient as would be charged an in-area patient.

To implement the exemplary embodiment, the business may choose an area or region of operation. Networks operating in the area are identified. Such networks may be approached for their agreement and/or participation. For example, a network may agree to allow the business to use the network's logo in service notifications provided to service providers. The network may be paid for this agreement. Data on the service providers in the area and associated with one or more of the identified networks may be compiled. The service providers associated with participating networks in the area may be referred to as eligible service providers. The business may make the data available to potential users.

The business may receive a response to a request from an out-of-area patient for a referral to a service provider selected from the data. The business may identify a matching network from the one or more identified networks with which the selected service provider is associated. The match between the network and the selected service provider may have previously been determined so the business may only have to identify that a match exists. In another embodiment, the business may only have to identify that a match exists, or the business may have to carry out the matching determination. The business instructs the selected service provider to charge a rate for a service to the out-of-area patient comparable to a rate charged to other patients associated with the matching network and receiving the service. The business may carry out the instruction by providing the selected service provider with a service notification, which may include the matching network's logo or other identification.

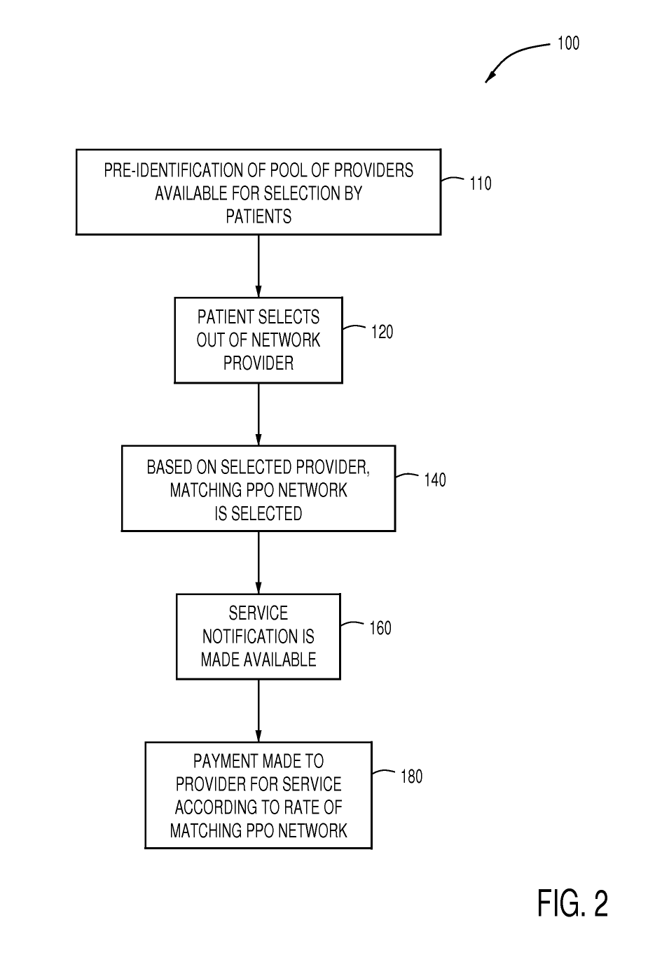

Additional embodiments of the inventions may be understood from the flow diagrams of FIGS. 2-4. FIG. 2 is an overview diagram and the other figures provide exemplary details.

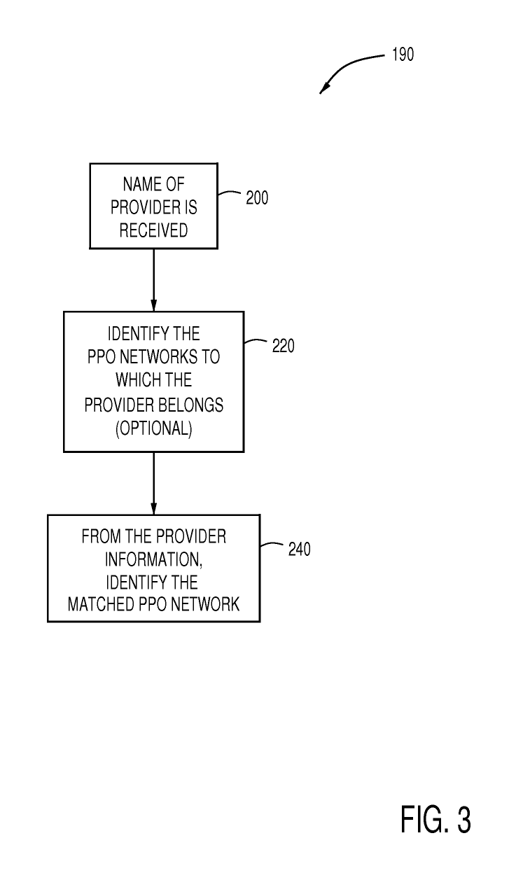

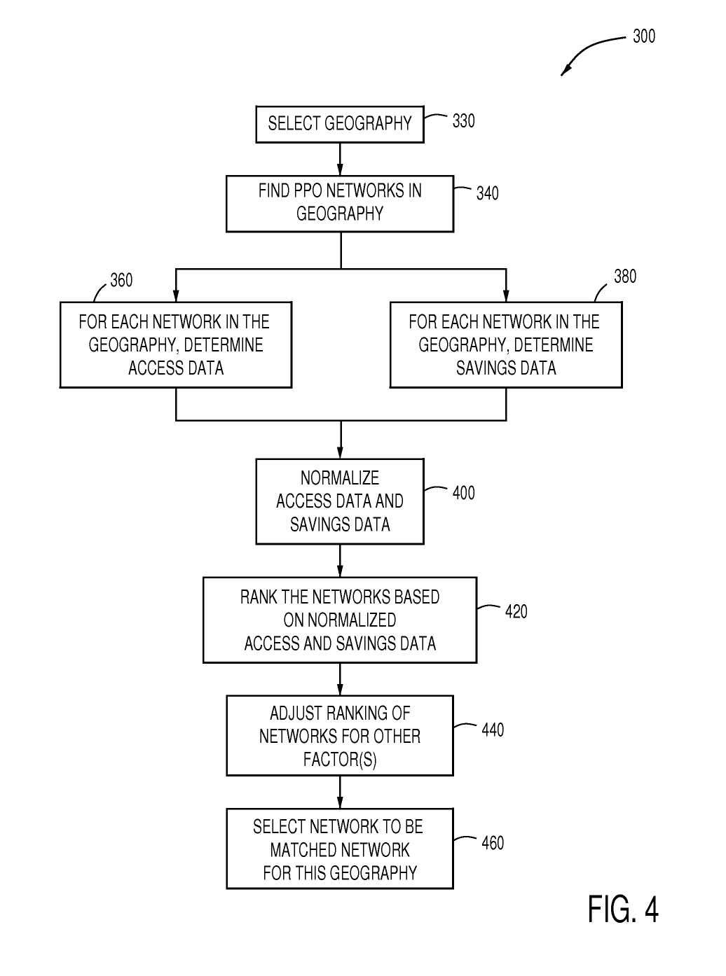

Referring to FIG. 2, the overall process 100 may begin with action 110, the pre-identification of the pool of all appropriate providers from which a selection may be made. In action 120 the patient selects a provider that is out of the patient's network and in the available pool of providers. In response to the patient's action, the exemplary embodiment uses the name of the selected provider in action 140 to find or select a “matched” or “matching” PPO network for the selected provider. The selected provider may participate in more than one PPO network. The exemplary embodiment may be used to find the best “match” as between the patient and the selected provider's PPO networks. Information on how the best match may be determined is provided below in connection with the discussion of FIGS. 3 and 4.

After the matching PPO network is found, a service notification may be made available in action 160. The service notification may include the name and logo of the matching PPO network as well as information relevant to the patient. The service notification may be made available to the patient and also may be made available to the out-of-network service provider selected by the patient. With respect to the patient, the service notification may be an “insurance card” with information regarding the particular transaction. In addition, the service notification may be made available to the payer of the patient's insurance coverage.

The patient may be required to present the service notification with the matching PPO's name and logo to the service provider at the time of service. For example, if a health insurance card is part of the service notification to the patient, the patient may present that card. The service provider submits a claim for payment to the payer listed on the service notification (or to a third-party as discussed above in the AJAX example). The payer (or third party) may pay the claim based on the rates and other factors that are part of the contractual relationship between the out-of-network service provider and the matching PPO network.

FIG. 3 includes a flow diagram 190 of exemplary method of how a PPO network may be matched to a service provider. The actions of flow diagram 190 may be considered sub-actions to action 110 and 140 of FIG. 2. In action 200, the identity of the provider is received. In optional action 220, the identity of the provider may be used to determine the network(s) in which the service provider participates. Action 220 may be optional because the exemplary embodiment may not need to determine all of the networks in which a provider participates in order to determine a matching PPO network. The exemplary embodiment may simply store the name of the service provider in a one-to-one relationship to the name of a matching PPO network (based on earlier compilation of such information). In action 240, the PPO network matching the service provider selection by the patient is determined (using optional action 220 or not).

FIG. 4 illustrates a flow diagram 300 of additional actions that may be taken in the determination of a matching PPO network for a selected service provider. The actions of flow diagram 300 may be considered sub-actions to action 240 of FIG. 3. In addition, the actions of flow diagram 300 may take place at a time prior to the patient's selection of an out-of-network service provider. In other words, a determination of a match between a service provider and a PPO network may be carried out in advance of patient participation such as in the set up of the system. Further, the determination of a match between a service provider and PPO network may be re-done on a periodic and/or on an as needed basis. The exemplary embodiment re-determines such matches every calendar quarter.

The match between a patient, provider and a PPO network may depend at least in part on the patient's benefit plan structure and the compliance of that structure with the provider's contract with the PPO network. The exemplary embodiment generally codifies the health care benefits plans of patients based upon key attributes. The exemplary embodiment may codify the adequate and sufficient health care benefit stipulations for access to each PPO network. The exemplary embodiment may then match and qualify the available PPO networks and their respective participating providers for each patient or patient healthcare benefit type. The pool of available providers for a patient may be reduced to those providers that participate in PPO networks available to the patient and to whom the patient has been identified.

The match between a service provider and a PPO network may also depend at least in part on geography. Each of the divisions and sub-divisions of a geographical area or region may be referred to as a “geography”. The exemplary embodiment generally selects the largest of the geographies in a geographic area and runs the process shown in flow diagram 300. The process is repeated for successively smaller geographies until there are no geographies left. Thus, the exemplary embodiment may run the process for a state, then for a metropolitan statistical area, then for a 3-digit ZIP code level, and then for 5-digit ZIP code level. The information from these processes may be stored and called upon as necessary. As noted, the processes may be re-done periodically and/or on an as needed basis. In the exemplary embodiment, the processes are carried out using actual data experience for all claims processed for the prior quarter.

Prior to the actions of flow diagram 300, the patients' health care benefits plans may be codified. Also, the patients' access to the pool of available PPO Network contracts may be identified. As noted previously, these actions may take place at times or organization of a particular implementation of an exemplary embodiment. They may be repeated in any particular program as needed, on a periodic basis, and/or otherwise.

Referring to flow diagram 300, in action 330 a geography is selected to begin the determination of a matching PPO network for a service provider. Typically, the service provider is located within the selected geography. In action 340, all (or as many as may be necessary or desired) of the PPO networks for the geography are found. Some embodiments may find less than all of the PPO networks for a geography.

In action 360 of the flow diagram 300 of FIG. 4, access data may be determined for each of the networks found in action 340 for the geography selected in action 330. Access data may include information on access to care such as by taking into account the total facilities available within the geography and the total primary care physicians within the geography. Access data may be determined by calculating a weighted rank for access based upon total provider count and facility count for each network. An absolute value rank based on the same data as the weighted rank also may be used as part of a determination of the access data. Other embodiments may omit the actions relating to the access data.

In action 380 of the flow diagram 300 of FIG. 4, savings data is determined for each of the networks found in action 340 for the geography. Savings data may be determined by looking at the average savings for in-patient care, out-patient care, primary care and ancillary services available from those providers for the geography. In determining savings data, consideration may be given to weighted average savings per network, weighted rank for savings for each network, and weighted absolute value savings for reach network. Other embodiments may omit the actions relating to savings data.

The normalization action 400 may be optional. In the exemplary embodiment, the access data found in action 360 may be normalized with respect to the savings data found in action 380. Other normalization may be used in alternative embodiments or in addition.

In action 420, the PPO networks in the geography are ranked based on the access and savings data found in the previous actions. If a normalization action was carried out, the ranking may be based on the normalized access and savings data. The exemplary embodiment may rank the networks for the geography based on a computation taking into account access rank, absolute access value, savings rank, and savings absolute value.

The exemplary embodiment may allow a client (such as a payer) to adjust the importance of savings versus access in the blend used in ranking networks in a geography. The weighting of savings versus access may be made to vary by payer based upon its priorities. For example, a payer could say: “If Hospital X has the best savings, then send everyone there and I don't care about Hospital Y.” As another example, a self-funded employer could say “No matter what—the CEO's primary care physician must be in the network or it will not be considered no matter what the savings”.

The ranking carried out in action 420 may be adjusted in action 440 to take into account factors other than and/or in addition to the access data and the savings data (and/or the normalized access and savings data). Factors that might be taken into account in adjusting the ranking of networks include: contract stipulations in the agreement between a PPO network and a service provider; preferred or mandatory access facilities; and/or other factors.

From the adjusted ranking of PPO networks, a PPO network may be selected in action 460 as the matching PPO network for the geography selected initially in action 330.

As noted above, the process of flow chart 300 may be repeatedly carried out in an ever granular manner to assign a matching PPO network for each of the geographies in a geographic area.

The exemplary embodiment may be implemented by a business. The business may gather, analyze, use, store and refresh the necessary information to implement the exemplary embodiment. The business also may operate an exemplary embodiment of the inventions on behalf of clients (such as payers and/or plan sponsors) in exchange for payment. For example, the business may contract with a payer to operate an exemplary embodiment on the payer's behalf. The advantage to the payer is that it may pay less than full cost on some out-of-network claims. Even though the payee pays the business a fee (such as part of the garnered savings), the savings over full cost payments may make the arrangement worthwhile for both parties.

An embodiment of the inventions may be referred to as a “virtual PPO network” because it extends the coverage of a PPO network beyond its physical presence in a particular geographic area. The “virtual PPO network” may convert a paper- and print-based process that is traditionally predefined for a twelve month period for an entire group of covered individuals into a dynamic and real-time operation. Features of the “virtual PPO network” may be Web-based so they may be accessed and delivered over the Internet.

For the individual, the “virtual PPO network” may take individual patient requirements and choices in PPO network and provider assignment into account. The “virtual PPO network” may also take into consideration an individual's account benefit plan design, the individual's geographic location at the time care is sought, and the contracts available for discounts with providers in the geographic area at that time. The “virtual PPO network” of the inventions may include identification and access capability for the patient.

For the medical service provider, the “virtual PPO network” may carry out the contractual requirements of steerage and notification that may be necessary for a provider's participation. This technique may permit optimized access to medical providers for the patient, the geographic location, the medical provider and the available medical provider contractual relationships, thereby, striving to result in the best or close to the best available pricing for healthcare.

Each time a participating patient seeks care, particularly when outside his or her normal healthcare service area, the identification and access capability of the “virtual PPO network” may lead to obtaining the most advantageous PPO discount available within the geography and relating to the provider type care that is sought. The “virtual PPO network” may assist in maximizing the healthcare cost savings to the healthcare benefits company, and the covered individual (for out-of-pocket costs). The provider may see incremental patient volume with a clearly defined method for how a claim will be administered, processed and paid.

The exemplary embodiments of the present inventions were chosen and described above in order to explain the principles of the invention and their practical applications so as to enable others skilled in the art to utilize the inventions including various embodiments and various modifications as are suited to the particular uses contemplated. The examples provided herein are not intended as limitations of the present invention. Other embodiments will suggest themselves to those skilled in the art. Therefore, the scope of the present inventions is to be limited only by the claims below.

I claim:

1. A method for a payer to save on healthcare costs with respect to a user seeking healthcare service, and for a service provider to be informed about payment for the sought-after healthcare service, comprising:
making data about eligible healthcare service providers available;
receiving a request for an eligible healthcare service provider to provide healthcare service to a user;
determining a matched preferred provider organization (PPO) network for the eligible healthcare service provider from among one or more PPO networks in which the healthcare service provider participates; and
providing the healthcare service provider with information at least relating to the user and the matched PPO network, the information causing the healthcare service provider to charge for healthcare service provided to the user substantially as the service provider charges an in-network user of the matched PPO network,
whereby the payer saves on healthcare costs because the user is charged for the healthcare service as an in-network user of the matched PPO, and
whereby the healthcare service provider is informed about the payment for the healthcare service at least by reference to the provided information relating at least to the user and the matched PPO network.

2. The method of claim 1, further comprising:
verifying participation of the healthcare service provider in the matched PPO network.

3. The method of claim 1, wherein determining the matched PPO network comprises:
if the healthcare service provider participates in more than one PPO network, determining access data for each of the PPO networks;
ranking the PPO networks based on the access data determination; and
selecting a top ranked PPO network to be the matched PPO network.

4. The method of claim 3, further comprising:
after determining the access data for each of the PPO networks, normalizing the access data determination; and
ranking the PPO networks based on the normalized access data.

5. The method of claim 3, further comprising:
after ranking the PPO networks and prior to selecting the top ranked PPO network to be the matched PPO network, adjusting the ranking of the PPO networks based on one or more factors.

6. The method of claim 1, wherein determining the matched PPO network comprises:
if the healthcare service provider participates in more than one PPO network, determining savings data for each of the PPO networks;
ranking the PPO networks based on their respective savings data; and
selecting a top ranked PPO network to be the matched PPO network.

7. The method of claim 6, further comprising:
normalizing each of the savings data; and
ranking the PPO networks based on their respective normalized savings data.

8. The method of claim 1, further comprising:
providing the user with the information at least relating to the user and the matched PPO network.

9. The method of claim 1, further comprising:
billing the payer at least for a portion of what the payer saves on the healthcare costs.

10. The method of claim 1, further comprising:
requesting payment from the payer at least for providing the healthcare service provider with the information relating to the user and the matched PPO network.

11. The method of claim 1, further comprising:
paying the matched PPO network at least for referencing the matched PPO network in the information.

12. A method to obtain a favorable rate for a patient for medical care from an out-of-network medical care giver, the method comprising:
receiving an inquiry about medical care for a patient in a region which is outside a region covered by the patient's network;
making data available about one or more medical care givers in the outside region eligible to provide the medical care at a favorable rate;
receiving identification of a medical care giver selected from the available data; and
causing the selected medical care giver to charge the favorable rate for the medical care.

13. The method of claim 12, wherein causing the selected medical care giver to charge the favorable rate comprises providing the selected medical care giver with a care notice at least identifying the patient as associated with a network in which the selected medical care giver participates.

14. The method of claim 13, wherein identifying the patient as associated with a network comprises:
determining one or more networks in which the selected medical care giver participates; and
selecting the network for associating with the patient in the care notice from the determined one or more networks in which the selected medical care giver participates.

15. The method of claim 12, further comprising:
charging a party responsible for medical care costs of the patient for obtaining the favorable rate for the medical care provided to the patient by the selected medical care giver.

16. A method of providing healthcare payment information to a healthcare provider with the information relating to a patient receiving healthcare service from the healthcare provider, comprising:
providing the healthcare provider with a service notification;
causing the service notification to identify the patient;
causing the service notification to identify a network in which the healthcare provider participates and with which the patient is associated,
whereby the identification in the service notification of the network allows the healthcare provider to determine a rate to be charged for the healthcare service to the patient.

17. The method of claim 16, further comprising:
causing the service notification to include a co-pay to be paid by the patient for the healthcare service provided by the healthcare provider.

18. Where a patient associated with a network is charged a rate for a service, a method of obtaining a comparable rate for the service provided to another patient, comprising:
identifying networks covering an area;
compiling data on the service providers providing service in the area and associated with one or more of the identified networks;
in response to a request from the other patient for a referral to a service provider selected from the data, identifying a matching network from the one or more identified networks with which the selected service provider is associated; and
instructing the selected service provider to charge a rate for a service to the other patient comparable to a rate charged to other patients associated with the matching network and receiving the service.
